(19) United States
(12) Patent Application Publication
(10) Pub. No.: US 2009/0184449 A1
(43) Pub. Date: Jul. 23, 2009

(54) Device for Holding and Positioning Implements, Workpieces and Tools

(75) Inventor: Juergen Drees, Mammelzen (DE)

Correspondence Address: HARNESS, DICKEY & PIERCE, P.L.C., P.O. BOX 828, BLOOMFIELD HILLS, MI, 48303, US

(73) Assignee: DE-STA-CO, Auburn Hills, MI (US)

(21) Appl. No.: 12/225,613

(22) PCT Filed: Nov. 16, 2006
(86) PCT No.: PCT/EP2006/012151

§ 371 Date: Mar. 18, 2009

(30) Foreign Application Priority Data
Jan. 19, 2006 (DE) 20 2006 000 908.6
Oct. 26, 2006 (DE) 20 2006 016 392.1

(51) Int. Cl. B23Q 1/25

(52) U.S. Cl. 269/71

(57) ABSTRACT

A device to hold and position implements, workpieces and tools has a console (1) with a support arm (2). A first end region (3) on the support arm (2) is arranged to receive a hinge joint arrangement (4) that can be connected to an implement holder (5). The hinge joint arrangement (4) defines two hinge axes (11, 14) that are offset by 90°. A positioning device (100) for the adjustment of an implement, workpiece (105) or tool, by shim technology and clamping, is associated with the console. The positioning device (1000 has a foot part (101) and a flange part (102) to hold the implement, workpiece (105) or tool. The implement holder is precisely adjusted in three planes or axes within an extremely restricted space to positionally fix an implement, workpiece or tool.

### CROSS-REFERENCE TO RELATED APPLICATIONS

This application is a National Stage of International Application No. PCT/JP2006/012151, filed Dec. 16, 2006, which claims priority to DE 20 2006 000 908.6, filed Jan. 19, 2006 and DE 20 2006 016 392.1, filed Oct. 26, 2006. The disclosures of the above applications are incorporated herein by reference.

### FIELD

The disclosure relates to a device to hold and position implements, workpieces and tools with a console that features a support arm. A hinge joint arrangement is arranged on the first end region of the support arm. The hinge joint arrangement can be connected to an implement holder and has two hinge axes that are offset by 90°. A positioning device serves to adjust, by means of shim technology, and clamp an implement, workpiece or tool and features a foot part and a flange part to accommodate the implement, workpiece or tool.

### BACKGROUND AND SUMMARY

Implements such as monitors, telephones or machine parts are frequently arranged on a stationary component such as, the body of a vehicle, the wall of a building, a tabletop or the like by means of a console. In order to variably position the respective implement, the implement holder may be arranged such that it can be pivoted, to a limited degree, relative to the support arm and fixed in the respectively adjusted position, by means of a screw connection.

Consoles also exist where a ball joint is arranged between the support arm and the implement holder in order to position an implement. Thus, the corresponding implement can be adjusted to a desired position in space relatively fast.

The disadvantage of such a ball joint arrangement is that the implement holder can only be fixed with relatively complicated measures. Thus, it is frequently required to axially displace the implement holder with the implement relative to a corresponding stationary stopping element that has the shape of a spherical cap.

In other known consoles, a hinge joint arrangement is provided on the end of the support arm of the console in order to position an implement. The hinge joint arrangement consists of two fork joints that are arranged in series. The hinge axes of the two fork joints are offset by 90°.

The disadvantage of such known hinge joint arrangements is that they have a relatively large space requirement because two separate joints are needed to be arranged in series. Thus, each joint also needs to be provided with its own fixing device in order to fix the position of the implement holder.

This applies analogously to consoles with hinge joints and fork joints that are arranged in series as is the common practice, for example, with consoles for monitors or telephones. These consoles also require two separate fixing devices in order to precisely fix the position of the corresponding implement.

Positioning and clamping devices generally serve to position or adjust and connect the workpiece or the tool in machine elements, systems, devices and the like during processing. They frequently not only support the processing forces, but also automatically move the workpiece or tool into a certain position required for realizing a flawless processing during the positioning and clamping process. A positioning and clamping device can always be used for workpieces or tools, the shapes and dimensions of which vary with in a certain range. Such positioning and clamping devices, as well as power clamping devices, are known in different variations. In addition to revolving workpiece and tool clamping devices such as points, tensioning spindles, collet chucks, clamping chucks and index mechanisms, there also exists a variety of fixed workpiece or tool clamping devices, such as fixed stays, vices, magnetic clamping devices, clamps, setup blocks, hand vices, etc.

The disadvantage of these clamping devices can be seen in their limited effective direction. Namely, the workpiece or tool can only be clamped in one plane or axis. More complex clamping devices also make it possible to clamp the workpiece or tool in two planes. Namely, in an X-direction and Y-direction. In certain instances, clamping occurs in three-dimensions. In the X-direction, the Y-direction and the Z-direction. However, these more complex clamping structures simply represent devices that consist of several combined clamping devices and therefore are technically complicated, voluminous and costly. Such complex clamping devices are usually unsuitable for smaller and high-precision processing steps and more compact work machines.

The so-called shim technology is frequently utilized for positioning or adjusting the implement, workpiece or tool on the positioning and/or clamping device. This technique is used, in particular, in valves for adjusting the valve clearance. In this case, shims or metal disks or metal plates with different thicknesses and, if applicable, different shapes are used to position and/or adjust the corresponding components of the device, the machine element, etc.

The disadvantage in this case can be seen in the increased space requirement to position or adjust and clamp the workpiece or the tool on the positioning and clamping device. The components required for the positioning, particularly the shims, are used outside the actual device. This can result in problems with respect to the placement of the shims and the components under restricted space conditions, particularly with compact or complex workpieces and tools, such that the components may impede one another.

It is an object to develop a device of the initially cited type that has a compact design and can be manufactured cost-efficiently. The implement holder of this device can be easily fixed in its position. An implement, workpiece or tool can be precisely adjusted in three planes or axes by the device within the most confined space possible.

According to the disclosure, a hinge joint arrangement of the console includes a first hinge element. The hinge element is cylindrical and arranged in a form-fitting fashion in a bearing bush in the support arm. It can be pivoted about the first hinge axis that forms the longitudinal axis of the first hinge element. The first hinge element of the console features a groove-shaped receptacle for a second hinge element. It can be connected to the implement holder. The second hinge element can be pivoted about the second hinge axis that extends through the first hinge element. The second hinge element extends outward through a recess in the first end region of the support arm. The support arm of the console features a slot-shaped recess. It extends from the lower region of the bearing bush in the direction of the second end region of the support arm. The first hinge element can be fixed by clamping, by pressing, together the two limbs of the support arm that are situated laterally adjacent to the slot-shaped recess. The pivoting range of the first hinge element of the console, as well as its design, is chosen such that the two limbs of the first hinge element, that enclose the second hinge element are also pressed together. The second hinge element is also fixed by clamping when the first hinge element is fixed. The foot part of the positioning device features a central opening with a square or rectangular cross section. An adjusting block of arbitrarily selectable thickness can be respectively mounted on at least two perpendicularly extending lateral surfaces of the opening. The flange part of the positioning device features a pin that corresponds to the shape of the opening in the foot part. The pin has smaller dimensions than the opening in the foot part. Also, the pin can be inserted into this opening. An adjusting plate of arbitrarily selectable thickness, with an opening that is congruent to the opening in the foot part, can be inserted between the foot part and the flange part of the positioning device. The pin of the flange part of the positioning device can be mounted in the opening of the foot part by a mounting element. The console features a flange plate that can be connected to the flange part of the positioning device.

In the console, a radial sliding bearing is used as a hinge joint arrangement. The bearing housing and the bearing bush are formed by the support arm. The shaft is formed by the cylindrical first hinge element. The first hinge element is in the form of a fork joint in the region of the bearing bush. Due to the special design of the bearing bush and of the first hinge element, the implement holder can be fixed by only one fixing device.

The console achieves a high stability due to the arrangement of the two joints in one plane. This is particularly important in the construction of devices and machines if the console is be used as an articulated console for power clamping devices, drilling and joining units, cylinder positioning elements, etc.

The console also provides the following important advantages in practical applications. The hinge joint arrangement makes it possible to precisely adjust both angles relative to a reference surface, with only two gauge blocks. The angular adjustments can be easily and reliably reproduced. Also, angular positions may be permanently secured, if so required, by setpins.

The side face of the support arm that faces the implement holder, in particular, or an imaginary or fictitious reference surface in this region may be considered as a reference surface. Such an imaginary or fictitious reference surface can practically be illustrated or generated at this location by two parallel pins. The pins are temporarily inserted into corresponding pocket-shaped recesses on the face side of the support arms that are spaced apart in the direction of the first hinge axis and situated above the hinge joint arrangement for only the adjustment duration.

After inserting the two pins into the pocket-shaped recesses of the support arm, the implement holder is adjusted by pivoting the implement holder about the two pivoting axes. If applicable, they are moved together with a fixed machine part until corresponding stopping surfaces, arranged laterally on the implement holder, press against the pins. Subsequently, the position of the implement holder can be fixed by the above-described fixing device.

In a first embodiment of the console, at least one stud is provided to press together the two limbs of the support arms that are situated laterally adjacent to the slot-shaped recess. The shaft of the stud can be screwed into an internal thread of one limb and the end of the stud on the head side is supported on the outside of the other limb.

In order to prevent an axial displacement of the first hinge element, it includes a curved, groove-shaped recess that extends in the circumferential direction on its side that faces the slot-shaped recess. A guide pin extends through a bore in the support arm to engage the recess. The curvature of the groove-shaped recess is chosen so that the first hinge element is able to carry out a defined pivoting motion.

The spacing between the edge regions of the recess in the first end region of the support arm is chosen in such a way that the pivoting motion of the first hinge element is limited by the edge regions.

In order to optimize the clamping effect of the first hinge element, that acts as a fork joint, a slot-shaped recesses extends between the walls of the receptacle on the bottom of the cylindrical recess. Alternatively, a slot-shaped recess is arranged in the region of the bottom side of the receptacle and extends from the outside of the first hinge element into the vicinity of the bottom of the recess.

In another embodiment, the position of the second hinge axis is chosen such that it intersects the first hinge axis. The intersection is in the central region of the first hinge element.

The positioning device can be mounted on a base such as, for example, a machine foundation or a mounting unit or the like with its foot part.

An advantage of the positioning device is that the positioning or adjusting of the implement, workpiece or tool takes place in all three planes or axes within the most confined space possible, within the device. Consequently, it is no longer necessary to provide more space or volume than is required by the device itself. The positioning of the implement, workpiece or tool on a mounting plate or the like is not required.

The positioning device makes it possible to precisely position or adjust an implement, workpiece or tool fixed onto the flange part in three planes or axes in the X-direction, the Y-direction and the Z-position. Subsequently, this implement, workpiece or tool is clamped in position. The exact thicknesses of the adjusting blocks and the adjusting plate are preferably determined with shims and gauge blocks. The arrangement of the adjusting blocks with the predetermined and selected thicknesses on the at least two perpendicular lateral surfaces of the opening in the foot part not only results in an exact dimensional adjustment in the X-direction by one of the adjusting blocks, but also an exact dimensional adjustment in the Y-direction by the other adjusting block, because it is aligned perpendicular to the adjusting block in the X-direction.

The square or rectangular cross section opening in the foot part ensures a non-slip contact of the adjusting blocks. This is due to its planar lateral surfaces.

In addition, an exact dimensional adjustment in the Z-direction, in the direction of the height of the positioning device, is achieved by the insertion of the adjusting plate with a predetermined and selected thickness.

It should be noted that it is generally possible to use several adjusting blocks and/or adjusting plates. Thus, the thicknesses of these adjusting blocks or adjusting plates add up to a predetermined dimension.

When the pin of the flange part is inserted into the opening in the foot part through the opening in the adjusting plate, the pin adjoins the adjusting blocks inserted into the opening in the foot part and the two exposed lateral surfaces of the opening. If the mounting element in the foot part is subsequently actuated such that the mounting element engages on the pin of the flange part, the pin is tightly clamped to the foot part. The adjusting plate is simultaneously tightly clamped to the flange part and the foot part.

Since the pin on the flange part has smaller dimensions than the opening in the foot part, a sufficient clearance remains to insert adjusting blocks with different thicknesses into the opening in the foot part. The clearance depends on the size of the positioning device itself, as well as on the difference between the diameter of the opening in the foot part and the diameter of the pin on the flange part.

In one embodiment of the positioning device, the positioning device has a rectangular or circular cross section. The foot part, the adjusting plate and the flange part have an isometric cross section. This makes it possible to manufacture the positioning device in a very compact and inexpensive fashion.

According to another embodiment of the positioning device, the pin of the flange part features a notch. The mounting element inserted onto the foot part engages the notch to lock the pin. The notch on the pin of the flange part in connection with the mounting element engaging on the foot part ensures that the foot part, the flange part and the adjusting plate are mutually clamped. The mounting element is in the form of a screw, for example, in the form of a hexagon socket screw or a set screw.

The corner regions of the opening in the foot part and the corner regions of the pin on the flange part may also be rounded. This eliminates sharp edges that could be damaged during frequent utilization of the positioning device due to the exchange of the adjusting blocks. Also, it eliminates the pin of the flange part from jamming in the opening of the foot part.

The notch is preferably arranged on a rounded corner region of the pin on the flange part. The mounting element is preferably arranged on a corresponding corner region of the foot part. These surfaces represent the most favorable working point for the mounting element and its engagement into the notch of the pin on the flange part.

It is also possible to mount the adjusting plate and/or the flange part on the foot part by pins or screws. This measure results in another non-slip connection between the flange part, the adjusting plate and the foot part, as well as an exact position of the adjusting plate.

The adjusting blocks may be mounted on the perpendicularly extending lateral surfaces of the opening in the foot part by pins or screws. This locks the adjusting blocks in the opening of the foot part in a non-slip fashion.

According to another embodiment of the positioning device, the upper side of the flange part also features a plurality of bores to mount a workpiece or tool, as described above, that is now exactly adjusted for further processing or operation, respectively.

The device includes an aluminum alloy, of steel or of plastic. The choice of the respective material depends on the intended use of the positioning device and the required accuracy of the adjusting and clamping process.

The console and the positioning device may also be used separately for their respective intended applications.

Further areas of applicability will become apparent from the description provided herein. The description and specific examples in this summary are intended for purposes of illustration only and are not intended to limit the scope of the present disclosure.

### DRAWINGS

Other details and advantages of the disclosure are described below with reference to embodiments that are illustrated in the drawings. In these drawings:

FIG. 1 is a perspective exploded view of a device in accordance with the disclosure.

FIG. 2 is an exploded perspective view of the console according to FIG. 1.

FIG. 3 is an enlarged section view of FIG. 2 along the line of section

FIG. 4 is an enlarged side view of the first hinge element of the console illustrated in FIG. 1.

FIG. 5 is a cross section view through the first hinge element of the console according to FIG. 4 along the line V-V.

FIG. 6 is an exploded view of a positioning device according to FIG. 1.

### DETAILED DESCRIPTION

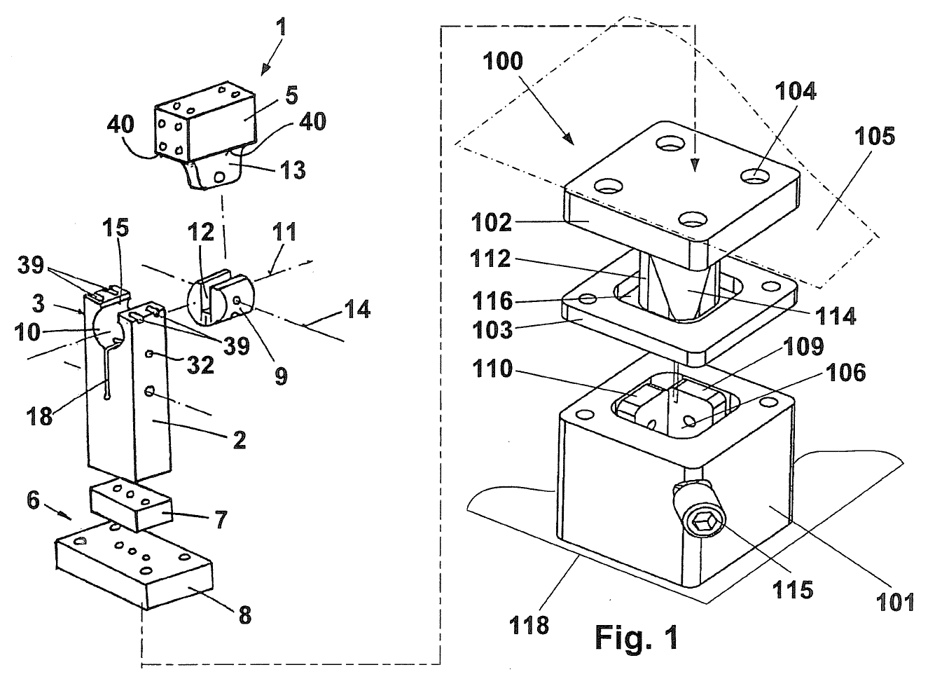

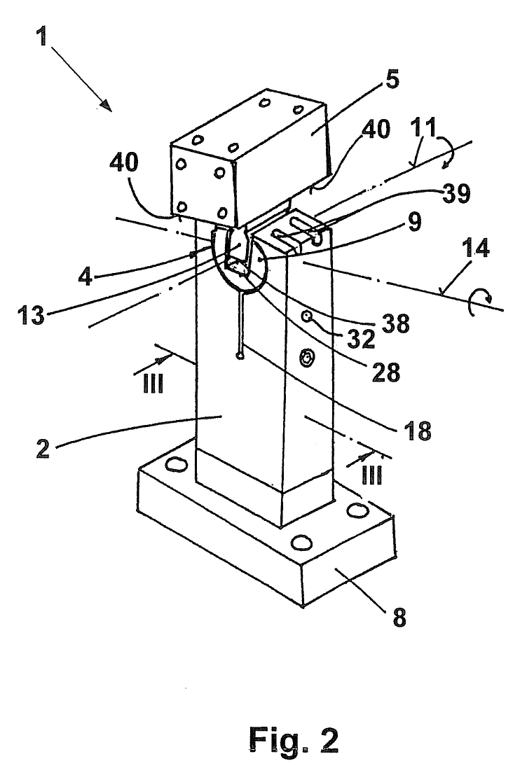

In FIG. 1 and FIG. 2, the reference numeral 1 identifies a console with a support arm 2. The support arm 2 is, for example, manufactured from an aluminum alloy. On its first end region 3, the support arm 2 is connected to an implement holder 5 by a hinge joint arrangement 4, A clamping device (not shown) for holding implements, workpieces or tools can be mounted on the implement holder.

On its second end region 6, the support arm 2 is connected to a flange plate 8 by an interface 7. The console 1 can be mounted on a support (not shown) such as, for example, a machine by the flange plate.

The hinge joint arrangement 4 includes a first cylindrical hinge element 9. It is manufactured from an aluminum alloy. The first hinge element is arranged in a form-fitting fashion in a bearing bush 10 in the support arm 2. It can be pivoted about a first hinge axis that forms the longitudinal axis 11 of the first hinge element 9.

In the region of the bearing bush 10, the first hinge element 9 includes a groove-shaped receptacle 12 that receives a second hinge element 13. The hinge element 13 can be connected to the implement holder 5. The second hinge element can be pivoted about a second hinge axis 14 that extends through the first hinge element 9. The second hinge element extends outward through a recess 15 in the first end region 3 of the support arm 2.

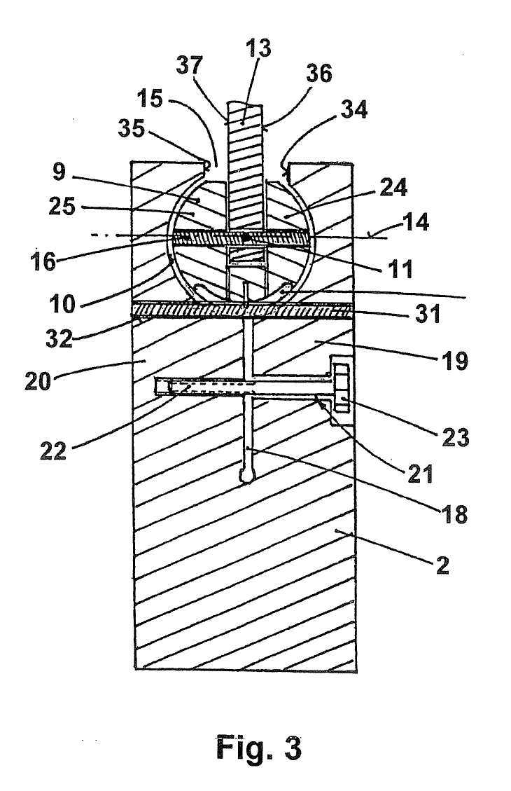

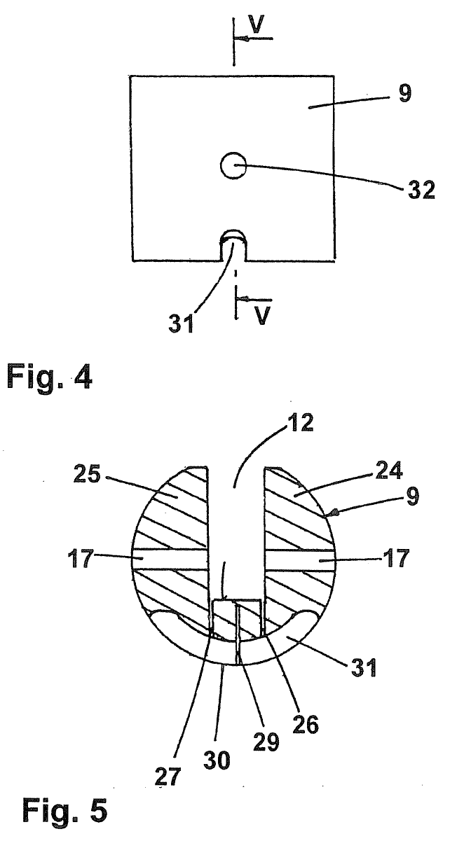

FIG. 3, in particular, illustrates the second hinge axis 14 in the form of a pin 16 that laterally extends through a corresponding bore 17 in the first hinge element 9. The position of the second hinge axis 14 is chosen such that it intersects the first hinge axis 11 in the central region of the first hinge element 9. Also, it intersects the bearing bush 10.

The support arm 2 includes a slot-shaped recess 18 that extends from the lower region of the bearing bush 10 in the direction of the second end region 6 of the support arm 2. Two limbs 19, 20 of the support arm 2 are situated laterally adjacent to the slot-shaped recess 18. They can be elastically pressed together and the first hinge element 9 can thusly be fixed by means of clamping, a frictional engagement.

In the embodiment illustrated in the figures, the two limbs 19, 20 of the support arm 2, that are situated laterally adjacent to the slot-shaped recess 18, are pressed together by means of a stud 21. The stud shaft 22 can be screwed into an internal thread of the limb 20. The stud end 23 on the head side is supported on the outside of the limb 19 as shown in FIG. 3.

The pivoting range of the first hinge element 9, as well as its design, is chosen such that the two limbs 24, 25 of the first hinge element 9, that enclose the second hinge element 13, are also pressed together. The second hinge element 13 is also fixed by means of clamping when the first hinge element 9 is fixed.

In order to simplify the process of elastically pressing together the two limbs 24, 25 of the first hinge element 9, it is proposed that the first hinge element 9 includes slot-shaped recesses 26, 27, on the bottom side 28, that extend both wall areas of the groove-shaped receptacle 12. Additionally, a slot-shaped recess 29 is formed in the bottom side 28, according to FIG. 5. Recess 29 extends from the outside 30 of the first hinge element 9 into the vicinity of the bottom 28 of the groove-shaped receptacle 12. They recess 29 is arranged in the region of the groove-shaped receptacle 12 on the bottom side. In this case, the slot-shaped recess 29 is arranged about centrally between the slot-shaped recesses 26 and 27.

In order to also prevent an axial displacement of the first hinge element 9 during the intended use of the console 1, it is proposed that it includes a curved, groove-shaped recess 31 that extends in the circumferential direction on its side that faces the slot-shaped recess 18 of the support arm 2. A guide pin 33 extends through a bore 32 in the support arm 2 and engages into the recess as shown in FIG. 3. In this case, the curvature of the groove-shaped recess 31 is chosen such that the first hinge element 9 is able to carry out a defined pivoting motion.

In the embodiment shown, the pivoting motion of the first hinge element 9 is defined by the spacing between the two edge regions 34, 35 of the recess 15 and the support arm 2 that come in contact with the lateral surfaces 36, 37 of the second hinge element 13 in a corresponding angular position of the first hinge element 9.

In one practical example, the pivoting angle of the first hinge element 9 is ±30° referred to as the initial position shown in FIG. 3. The pivoting angle of the second hinge element 13 is ±10° in this example. Among other things, it depends on the spacing between the surface 38 of the second hinge element 13 that faces the bottom 28 of the groove-shaped receptacle 12 and the bottom 28.

The above-described hinge joint arrangement also makes it possible to very accurately and reproducibly adjust angular positions of the implement holder 5 and also the clamping device relative to the support arm 2. For this purpose, pocket-shaped recesses 39 are provided in the face side of the support arm 2 that face the implement holder 5 and are spaced apart in the direction of the first hinge axis 11. A pin, not shown, is respectively inserted into two recesses 39 that are arranged in series. The corresponding outside diameters of the pins define the angular positions.

After inserting the two pins into the pocket-shaped recesses 39 of the support arm 2, the implement holder 5 is adjusted by pivoting the implement holder about the two pivoting axes 11, 14, if applicable, together with the clamping device fixed thereon, until corresponding stopping surfaces 40 arranged laterally on the implement holder 5 contact the surfaces of both pins. Subsequently, the position of the implement holder 5 can be fixed by the stud 21.

The console naturally is not restricted to the above-described embodiment. For example, the two limbs 19, 20 of the support arm 2 may also be pressed together in order to clamp the first hinge element 9 by two studs or a screw connection with separate nuts.

Furthermore, an axial displacement of the first hinge element 9 can also be reliably prevented by respectively providing the first hinge element 9 with a collar on both of its ends.

The pivoting motion can also be limited by choosing the length of the curved, groove-shaped recess 31 rather than by specifying the spacing between the edge regions of the recess in the support arm 2.

The console does not necessarily need be of an aluminum alloy, but could also be made of other materials such as, steel or plastic in accordance with the respective requirements of the console.

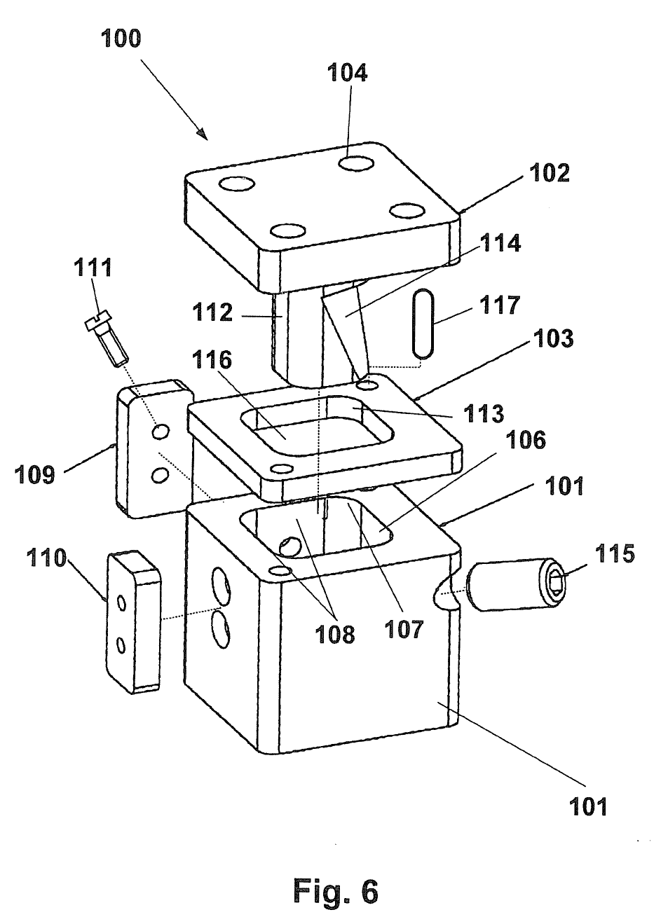

The positioning device 100 according to FIGS. 1 and 6 also, for example, is manufactured from an aluminum alloy, steel or plastic. Its major components are a foot part 101, a flange part 102 and an adjusting plate 103 that can be inserted between the two. On its upper side, the flange part 102 has a plurality of bores 104 for mounting, the above-described console 1 or a workpiece 105 that is schematically illustrated in dot-dash line in FIG. 1. The positioning device 100 has a rectangular cross section and its major components have an isometric cross section.

The foot part 101 includes a centrally arranged square opening 106. However, the corner regions 107 of the opening 106 are rounded. An adjusting block 109, 110 is respectively mounted on each of two perpendicularly extending lateral surfaces 108 of the opening 106 by screws 111, of which only one is illustrated in FIG. 2. The respective adjusting blocks 109, 110 have a certain arbitrarily selectable thickness. In this case, the adjusting block 109 may have a thickness different than the adjusting block 110. The adjusting block 110 enables a dimensional adjustment for clamping the workpiece in the X-direction. The adjusting block 109 enables a dimensional adjustment in the Y-direction.

A pin 112 is integrally formed on the underside of the flange part 102. The pin has a shape that corresponds to the shape of the opening 106 in the foot part 101. However, it has smaller dimensions. Its diameter is significantly smaller than the opening 106 in the foot part 101. This pin 112 is rounded on its corner regions 113 analogous to the corner regions 107 of the opening 106 in the foot part 101. A notch 114 is machined into the pin 112 of the flange part 102 in one of these corner regions 113. A mounting element 115, inserted into the foot part 101, such as, for example, a hexagon socket screw, engages into this notch 114 when the flange part 102 with the pin 112 is inserted into the foot part 101. This mounting element 115 mutually clamps the foot part 101, the flange part 102 and the adjusting plate 103 relative to the adjusting blocks 109, 110. In this case, the oblique surface of the notch 114 promotes the clamping effect relative to the mounting element 115.

The adjusting plate 103 arranged between the foot part 101 and the flange part 102 has a predetermined thickness that can be arbitrarily selected. This adjusting plate provides a dimensional adjustment in order to clamp the workpiece in the Z-direction. The adjusting plate 103 features a central opening 116 with the same contour and size as the opening 106 in the foot part 101 of the positioning device 100.

The pin 112 of the flange part 102 is guided by this opening 116 when the connection with the foot part 101 is produced. The adjusting plate 103 can be locked on the foot part 101 by pins 117, of which only one is illustrated in FIG. 2.

According to FIG. 1, the positioning device 100 is mounted on a schematically illustrated base 118 such as, a machine table.

The present disclosure has been described with reference to the preferred embodiments. Obviously, modifications and alternations will occur to those of ordinary skill in the art upon reading and understanding the preceding detailed description. It is intended that the present disclosure be construed as including all such alternations and modifications insofar as they come within the scope of the appended claims or their equivalents.

What is claimed is:

1-18. (canceled)

19. A device for holding and positioning implements, workpieces and tools, with a console comprising:
a hinge joint arrangement coupling with the console comprises a first hinge element arranged in a form-fitting fashion in a bearing bush in the console for pivotal movement about a first hinge axis;
a second hinge element coupling with said first hinge element for pivotal movement about a second hinge axis that extends through the first hinge element; and
a support arm of the console includes a recess extending from the bearing bush dividing the support arm into two limbs, said first hinge element and second hinge element can be fixed by clamping or pressing together said two limbs of the support arm.

20. The device according to claim 19, further comprising at least one stud for pressing together the two limbs of the support arm of the console, wherein a shaft of said stud can be screwed into an internal thread of one limb and its end on a head side is supported on the outside of the other limb.

21. The device according to claim 19, wherein an axial displacement of the first hinge element is prevented by a curved, groove-shaped recess on the first hinge element, said groove extends in a circumferential direction on its side that faces the recess, and a guide pin extends through a bore in the support arm and engages into said recess, and said curvature of the groove-shaped recess enables the first hinge element to carry out a defined pivoting motion.

22. The device according to claim 19, wherein spacing between edge regions of the recess in the support arm of the console enabling pivoting motion of the first hinge element is limited by the edge regions.

23. The device according to claim 19, wherein the first hinge element includes a slot-shaped recess in a region, wherein said slot-shaped recess extends from an outside of the first hinge element into a vicinity of the bottom of a groove.

24. The device according to claim 19, wherein the position of the second hinge axis of the second hinge element enables the two hinge axes of the hinge joint arrangement of the console to intersect.

25. The device according to claim 19, wherein two pocket-shaped recesses are provided in the side face of the support arm, one respective pin can be inserted into these pocket-shaped recesses, and an outside diameter of said pins defines both angular positions of the support arm, stopping surfaces are laterally provided on console so that the stopping surfaces facing the pins contact the surface of the pins as soon as the predetermined angular positions are reached.

26. The device of claim 19, further comprising a foot part of the positioning device includes a central opening receiving adjusting block of a desired thickness can be respectively mounted in said opening;
a flange part of the positioning device includes a pin that corresponds to the shape of the opening in the foot part, said pin has smaller dimensions than the opening in the foot part and can be inserted into this opening;
an adjusting plate of a desired thickness spaces the foot part from the flange part of the positioning device;
said pin of the flange part of the positioning device can be mounted in the opening of the foot part by a mounting element; and
a flange plate of the console can be connected to the flange part of the positioning device.

27. The device according to claim 26, wherein the positioning device has a rectangular or circular cross section, and the foot part, the adjusting plate and the flange part have an isometric cross section.

28. The device according to claim 26, wherein the pin of the flange part of the positioning device has a notch that receives the mounting element that can be inserted into the foot part to engage and lock the pin.

29. The device according to claim 26, wherein corner regions of the opening in the foot part and the corner regions of the pin on the flange part of the positioning device are rounded.

30. The device according to claim 28, wherein the notch is rounded in a corner region of the pin on the flange part, and the mounting element is arranged on a corresponding corner region of the foot part.

31. The device according to claim 26, wherein the adjusting plate and the flange part of the positioning device are mounted on the foot part by pins or screws.

32. The device according to claim 26, wherein the adjusting blocks can be mounted on perpendicularly extending lateral surfaces of the opening in the foot part of the positioning device by pins or screws.

33. The device according to claim 26, wherein an upper side of the flange part of the positioning device includes a plurality of bores for mounting an implement, workpiece or tool.

34. The device according to claim 19, wherein it is manufactured from an aluminum alloy, of steel or of plastic.

35. A device for holding and positioning implements with a console, and a support arm, and a hinge joint arrangement with two hinge axes that are offset by 90°, said hinge joint arrangement comprises:
a first hinge element that is cylindrically arranged in a form-fitting fashion in a bearing bush in said support arm;
said first hinge element is pivotal about a first hinge axis that forms a longitudinal axis of the first hinge element;
a second hinge element pivotal with respect to said first hinge element and said second hinge element also fixed by clamping when the first hinge element is fixed;
a groove shaped receptacle in the first hinge element, said groove-shaped receptacle receives said second hinge element that may be connected to an implement holder; and
a slot shaped recess in the support arm of the console, said slot-shaped recess extends from a lower region of the bearing bush in a direction of a second end region of the support arm.
